(19) United States
(12) Patent Application Publication
(10) Pub. No.: US 2007/0050956 A1
(43) Pub. Date: Mar. 8, 2007

(54) APPARATUS FOR CARRYING TOOLS

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,315

(22) Filed: Sep. 6, 2005

(51) Int. Cl. F16B 45/02

(52) U.S. Cl. 24/598.2

(57) ABSTRACT

There is disclosed an apparatus for carrying tools. The apparatus includes a body and a latch. The body includes a pivotal connection end, an abutment end separated from the pivotal connection end and a hanging section formed between the pivotal connection end and the abutment end. The hanging section includes a rough surface for providing adequate friction between itself and the tools so that the movement of the tools on the hanging section is limited and that the tools can be put on and taken from the hanging section in a convenient and fast manner. The latch includes a pivotal connection end pivotally connected to the pivotal connection end of the body and an abutment end for abutment against the abutment end of the body in an elastic manner.

### BACKGROUND OF INVENTION

1. Field of Invention

The present invention relates to an apparatus for carrying tools and, more particularly, to an apparatus including a non-slip surface for carrying tools.

2. Related Prior Art

Referring to FIGS. 1 and 2, there is shown a conventional apparatus 1 for carrying tools. The conventional apparatus 1 includes a substantially triangular body and a latch 2. The body is a bent bar. The body includes first and second hanging sections 3 and first and second ends respectively extending from the first and second hanging sections 3 towards but not contacting each other. The latch 2 includes a first end pivotally connected to the first end of the body and a second end for abutment against the second end of the body. The latch 2 includes a hole 6 in the first end in order to receive a spring 5. A contact strip 4 includes an end connected to the spring 5 and another end put against the first end of the body. The latch 2 can be pivoted, thus deforming the spring 5. Now, the box ends of box wrenches can be moved onto the second hanging section 3 for example. When the latch 2 is released, it is returned by means of the spring 5 in order to keep the box ends of the box wrenches on the body. A bent portion near the first hanging section 3 can be hung on a nail. However, as the hanging sections 3 include smooth surfaces, the box ends often slide to an end of the first hanging section 3 because of an external force or poor balance of the structure of the body. In this case, the first hanging section 3 is tilted, and the box wrenches are not hung on the first hanging section 3 stably. The box wrenches cannot be put onto or taken from the first hanging section 3 easily. Therefore, the use of the apparatus 1 is inconvenient. Moreover, the latch 2 is processed in two steps. The processing of the latch 2 is complicated. Furthermore, the biasing of the latch 2 requires two elements, i.e., the spring 5 and the contact strip 4. Thus, the elements are numerous and the resultant structure is complicated. The working and assembling is troublesome. Hence, the making of this conventional apparatus 1 takes a lot of time and is expensive.

The present invention is therefore intended to obviate or at least alleviate the problems encountered in prior art.

### SUMMARY OF INVENTION

According to the present invention, there is disclosed an apparatus for carrying tools. The apparatus includes a body and a latch. The body includes a pivotal connection end, an abutment end separated from the pivotal connection end and a hanging section formed between the pivotal connection end and the abutment end. The hanging section includes a rough surface for providing adequate friction between itself and the tools so that the movement of the tools on the hanging section is limited and that the tools can be put on and taken from the hanging section in a convenient and fast manner. The latch includes a pivotal connection end pivotally connected to the pivotal connection end of the body and an abutment end for abutment against the abutment end of the body in an elastic manner.

An advantage of the apparatus according to the present invention is that the box wrenches can be hung on the hanging section stably and neatly because of the rough surface so that the box wrenches can be put on and taken from the hanging section conveniently and quickly.

Another advantage of the apparatus according to the present invention is that it involves a low cost for including a simple structure made of only a few elements.

Other advantages and novel features of the invention will become more apparent from the following detailed description in conjunction with the drawings.

### BRIEF DESCRIPTION OF DRAWINGS

The present invention will be described through detailed illustration of embodiments referring to the drawings.

FIG. 1 is a perspective view of a conventional apparatus for carrying tools such as box wrenches.

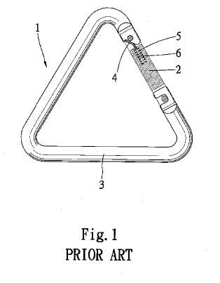

FIG. 2 is an exploded view of the apparatus shown in FIG. 1.

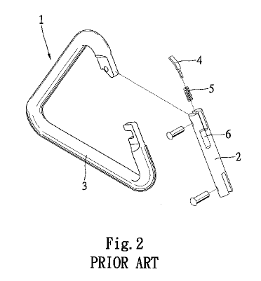

FIG. 3 is a perspective view of an apparatus for carrying tools such as box wrenches according to a first embodiment of the present invention.

FIG. 4 is an exploded view of the apparatus shown in FIG. 3.

FIG. 5 is a cutaway diagram of the apparatus shown in FIG. 3.

FIG. 6 is similar to FIG. 5 but shows the apparatus open in order to receive tools.

FIG. 7 is a reduced side view of the apparatus shown in FIG. 3 already carrying tools.

FIG. 8 is a side view of an apparatus for carrying tools such as box wrenches according to a second embodiment of the present invention.

FIG. 9 is a side view of an apparatus for carrying tools such as box wrenches according to a third embodiment of the present invention.

### DETAILED DESCRIPTION OF EMBODIMENTS

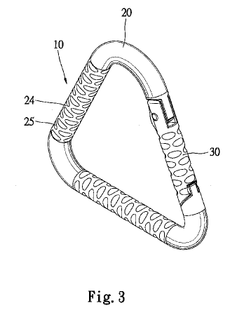

Referring to FIGS. 3 through 7, there is shown an apparatus 10 for carrying tools such as box wrenches 40 according to a first embodiment of the present invention.

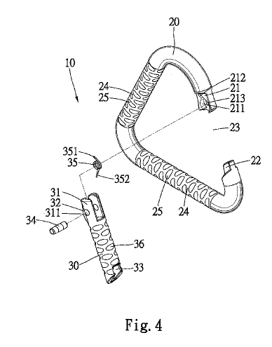

Referring to FIGS. 3 and 4, the apparatus 10 includes a substantially triangular body 20 and a latch 30. The body 20 may be a bent bar. The body 20 includes a first hanging section 24, a second hanging section 24, a reduced flat pivotal connection end 21 extending from the first hanging section 24, and a reduced flat abutment end 22 extending from the second hanging section 24. A plurality of recesses 25 is defined in the surface of each of the hanging sections 24. The surface of each of the hanging sections 24 is rough and will provide adequate friction between itself and the box ends of the box wrenches 40. The pivotal connection end 21 extends towards but does not contact the abutment end 22. A circular cavity 211 and a narrow cavity 212 are defined in the pivotal connection end 21 and communicated with each other. An aperture 21 3 is defined in the floor of the circular cavity 211.

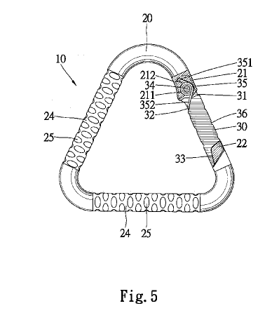

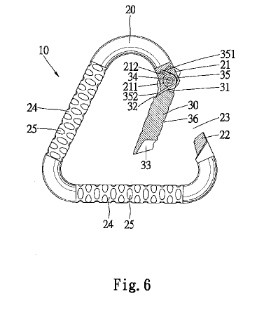

A helical spring 35 includes a first end 351 and a second end 352. The helical spring 35 is put substantially in the circular cavity 211, with the first end 351 in the narrow cavity 212 and the second end 352 outside the circular cavity 211 as best shown in FIGS. 5 and 6.

The latch 30 includes a pivotal connection end 31 connected to the pivotal connection end 21 of the body 20 pivotally and an abutment end 33 for abutment against the abutment end 22 of the body 20. At the pivotal connection end 31 are formed two ears (not numbered) each of which defines an aperture 311. The pivotal connection end 21 is put between the ears. A pin 34 is fit in the aperture 21 3 through the apertures 311. Thus, the pivotal connection end 31 is connected to the pivotal connection end 21 pivotally. A stop 32 is formed between the ears and abutted against the second end 352 of the spring 35. Thus, the spring 35 provides a torque between the pivotal connection end 21 and the pivotal connection end 31. The abutment end 33 defines a recess (not numbered) for receiving the abutment end 22 so that the abutment end 33 will not rattle on the abutment end 22. A plurality of recesses 36 is defined in the surface of the latch 30. The surface of the latch 30 is rough and will provide adequate friction between itself and the box ends of the box wrenches 40.

Referring to FIG. 5, the abutment end 33 is abutted against the abutment end 22. As discussed above, the spring 35 provides a torque between the pivotal connection end 21 and the pivotal connection end 31. Because of this torque, the abutment end 33 is kept against the abutment end 22, i.e., the apparatus 10 is kept closed.

Referring to FIG. 6, the latch 30 is pivoted on the body 20. The spring 35 is further deformed. The torque in the spring 35 is increased. The abutment end 33 is moved from the abutment end 22. That is, the latch 30 is open. Now, the box ends of box wrenches 40 can be put onto the second hanging section 24 past the latch 30.

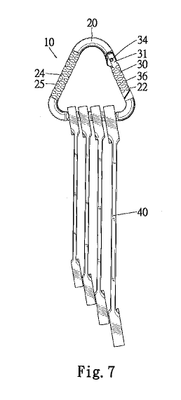

Referring to FIG. 7, the latch 30 is released. The latch 30 is returned by means of the spring 35 in order to keep the box ends of the box wrenches 40 on the body 20. The box ends of the box wrenches 40 are put on the second hanging section 24 stably and neatly. That is, the box ends of the box wrenches 40 will not easily slide on the second hanging section 24 because of the adequate friction between them. The adequate friction is made possible by the rough surface in which the recesses 25 are defined. A bent portion near the first hanging section 24 can be hung on a nail. Alternatively, the box ends of the box wrenches 40 can be put on the first hanging section 24. A bent portion near the second hanging section 24 can be hung on a nail.

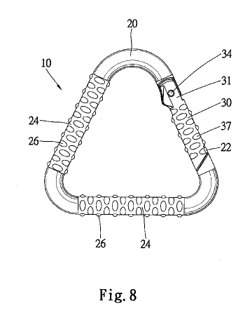

Referring to FIG. 8, there is shown an apparatus 10 according to a second embodiment of the present invention. The second embodiment is identical to the first embodiment except two things. Firstly, bosses 26 are used instead of the recesses 25. The bosses 26 make the surfaces of the hanging sections 24 rough. Secondly, bosses 37 are used instead of the recesses 36. The bosses 37 make the surface of the latch 30 rough.

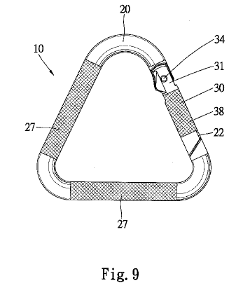

Referring to FIG. 9, there is shown an apparatus 10 according to a third embodiment of the present invention. The third embodiment is identical to the first embodiment except two things. Firstly, an indented texture 27 is used instead of the recesses 25. The indented textures 27 make the surfaces of the hanging sections 24 rough. Secondly, an indented texture 38 is used instead of the recesses 36. The indented texture 38 makes the surface of the latch 30 rough.

The apparatus 10 exhibits at least two advantages over the conventional apparatus 1 discussed in the Related Prior Art.

Firstly, the hanging sections 24 include the recesses 25, bosses 26 or indent textures 27 that make the surfaces thereof rough. The rough surfaces can provide adequate friction between the hanging sections 24 and the box wrenches 40. When the box wrenches 40 are hung on the hanging sections 24, the sliding of the former on the latter is limited. In other words, the box wrenches 40 will not easily slide on the hanging sections 24 because of an external force or poor balance of the structure of the apparatus 10. That is, the box wrenches 40 will be hung on the hanging sections 24 stably and neatly. The box wrenches 40 can be put on and taken from the hanging sections 24 conveniently and quickly.

Secondly, there is only one spring 35 between the pivotal connection end 31 of the latch 30 and the pivotal connection end 21 of the body 20. The spring 35 is sufficient to cause the latch 30 to close the body 20 normally. This design not only simplifies the structure through reducing the number of elements but also reduces the cost through reducing the time taken for the working and assembling made possible by involving one-step working on the latch 30.

The present invention has been described through the detailed description of the embodiments. Those skilled in the art can derive variations from the embodiments without departing from the scope of the present invention. Therefore, the embodiments shall not limit the scope of the present invention defined in the claims.

What is claimed is:

1. An apparatus for carrying tools comprising:
a body comprising a pivotal connection end, an abutment end separated from the pivotal connection end and at least one hanging section formed between the pivotal connection end and the abutment end, the hanging section comprising a rough surface for providing adequate friction between itself and the tools so that the movement of the tools on the hanging section is limited and that the tools can be put on and taken from the hanging section in a convenient and fast manner; and
a latch comprising a pivotal connection end connected to the pivotal connection end of the body pivotally and an abutment end for abutment against the abutment end of the body in an elastic manner.

2. The apparatus according to claim 1 comprising a spring between the pivotal connection end of the latch and the pivotal connection end of the body in order to provide a torque for returning the latch.

3. The apparatus according to claim 1 wherein the body is in the form of an isosceles triangle substantially.

4. The apparatus according to claim 1 wherein the body is in the form of an equilateral triangle substantially.

5. The apparatus according to claim 1 wherein the rough surface of the hanging section is caused by a plurality of recesses.

6. The apparatus according to claim 1 wherein the rough surface of the hanging section is caused by a plurality of bosses.

7. The apparatus according to claim 1 wherein the rough surface of the hanging section is caused by an indent texture.

8. The apparatus according to claim 1 comprising a pin fit in the pivotal connection end of the latch and the pivotal connection end of the body in order to pivotally connect the pivotal connection end of the latch to the pivotal connection end of the body.

9. The apparatus according to claim 2 wherein the pivotal connection end of the body comprises a circular cavity defined therein and a narrow cavity defined therein and communicated with the circular cavity, wherein the spring is put substantially in the circular cavity and comprises a first end put in the narrow cavity and a second end abutted against an abutment portion of the latch.

10. The apparatus according to claim 1 wherein the latch closes the body normally.

11. The apparatus according to claim 1 wherein the surface of the latch is made rough.

12. The apparatus according to claim 11 wherein the rough surface of the latch is caused by means of a plurality of recesses.

13. The apparatus according to claim 11 wherein the rough surface of the latch is caused by means of a plurality of bosses.

14. The apparatus according to claim 11 wherein the rough surface of the latch is caused by means of an indented texture.
